(19) United States
(12) Patent Application Publication
(10) Pub. No.: US 2007/0167535 A1
(43) Pub. Date: Jul. 19, 2007

(54) Hardenable materials, containing disagglomerated barium sulfate, method for production and use thereof

(75) Inventors: Andreas Poppe, Sendenhorst (DE); Dunja Mikolajetz, Ascheberg (DE); Elke Westhoff, Steinfurt (DE); Ferdinand Hardinghaus, Bad Honningen (DE); Jai-Won Park, Gottingen (DE); Karl Kohler, Diekholzen (DE); Rainer Stahl, Arnsberg (DE); David Christopher Glende, Esebeck (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AG, 48165 MuNSTER (DE)

(21) Appl. No.: 10/596,007

(22) PCT Filed: Nov. 11, 2004
(86) PCT No.: PCT/EP04/53031

§ 371 Date: Jan. 30, 2007

(30) Foreign Application Priority Data
Dec. 6, 2003 (DE) 103 57 114.0
Mar. 2, 2004 (DE) 10 2004 010 201.5

(51) Int. Cl. B29C 71/04

(52) U.S. Cl. 522/71; 977/902

(57) ABSTRACT

Curable compositions comprising deagglomerated barium sulfate containing at least one dispersant and at least one crystallization inhibitor and having a primary particle size <0.5 μm, preferably <0.1 μm, in particular <30 nm, and their use.

The present invention relates to new curable compositions comprising deagglomerated barium sulfate. The present invention also relates to a new process for preparing curable compositions comprising deagglomerated barium sulfate. The present invention relates not least to the use of the new curable compositions comprising deagglomerated barium sulfate and of the curable compositions comprising deagglomerated barium sulfate that are prepared by the new process for producing new cured compositions.

Curable compositions comprising nanoparticles, especially nanoparticles based on silica or alumina, have long been known. By way of example, reference may be made to patent applications EP 1 179 575 A2, WO 00/35599 A, WO 99/52964 A, WO 99/54412 A, WO99/52964 A, DE 197 26 829 A1 or DE 195 40 623 A1. They are used in particular to produce coatings whose scratch resistance is high but whose chemical stability leaves something to be desired.

European patent application EP 0 943 664 A2 discloses nanoparticle-containing, transparent film-forming binders which, based on the coating material solids, contain from 0.5 to 25% by weight of primarily nanoscale particles, incorporated in solid form, and which are prepared by nozzle jet dispersion of the nanoscale particles in the binder. The greater ease of incorporation of the nanoparticles raises the scratch resistance of the cured compositions produced from the cured film-forming binders. Besides numerous other species, barium sulfate nanoparticles are among those which can be used. Whether these particles are deagglomerated or not, and what influence they exert over gloss, transparency, clarity, leveling, surface quality, scratch resistance, and chemical stability, are not revealed by the European patent application.

It is an object of the present invention to provide new curable compositions which yield new cured compositions exhibiting high gloss, very good leveling, no stress cracks, a surface free from defects, such as craters, bits, microbubbles, and pinholes, and a high scratch resistance. Unless the new cured compositions are opaque they ought to be particularly transparent, clear, and bright. They ought further to have a very good chemical resistance. Not least they ought to provide substrates of all kinds with effective shielding from high-energy radiation, particularly x-rays. Furthermore, the new curable compositions ought to be easy to prepare.

The invention accordingly provides the new curable compositions which comprise deagglomerated barium sulfate containing at least one dispersant, including nanoparticles containing at least one crystallization inhibitor and having a primary particle size <0.5 μm, preferably <0.1 μm, in particular <30 nm, and referred to below as “curable compositions of the invention”.

Additional subject matter of the invention will emerge from the description.

In the light of the prior art it was surprising and unforeseeable for the skilled worker that the object on which the present invention was based could be achieved by means of the curable compositions of the invention.

A particular surprise was that the curable compositions of the invention were particularly easy to prepare with very good reproducibility.

Even with a high deagglomerated barium sulfate content and a solids content >30% by weight the resultant curable compositions of the invention, were, surprisingly, very readily transportable and stable on storage and lent themselves very well to further processing, in particular to application to substrates.

The curable compositions of the invention were therefore capable of surprisingly broad application. In particular they were outstandingly suitable for use as coating materials, adhesives, and sealants and also as starting products for moldings and self-supporting sheets.

The curable compositions of the invention yielded cured compositions of the invention which had a high gloss, very good leveling, and high scratch resistance. Even in layer thicknesses >40 μm the cured compositions of the invention showed no stress cracks and had a surface that was free from defects, such as craters, bits, microbubbles, and pinholes. Where the cured compositions of the invention were not opaque, they were particularly transparent, clear, and bright. Furthermore, they exhibited a very good chemical resistance and, not least, they shielded substrates of all kinds effectively against high-energy radiation, particularly X-rays.

Accordingly, the cured compositions of the invention were capable of surprisingly broad application. In particular they could be used as coatings, adhesive layers, and seals, and also as moldings and self-supporting sheets.

The deagglomerated barium sulfate comprises particles with a mean (primary) particle size <0.5 μm containing a crystallization inhibitor and a dispersant. The deagglomerated barium sulfate preferably consists of these particles. Preference is given to deagglomerated barium sulfate having a mean (primary) particle size of <0.1 μm, in particular <0.08 μm (=80 nm), very preferably <0.05 μm (=50 nm), in particular <0.03 μm (=30 nm). Particle sizes <20 μm are outstanding, with very particular preference attaching to a mean primary particle size of <10 nm. The lower limit for the primary particle size is, for example, 5 nm, but this size may be even lower. The mean particle sizes in question are those determined by the laser diffraction method or by XRD. A preferred deagglomerated barium sulfate is obtainable by precipitating barium sulfate in the presence of an agent which inhibits crystallization, with a dispersant present during precipitation and/or the barium sulfate being deagglomerated after precipitation in the presence of a dispersant.

The amount of crystallization inhibitor and dispersant in the deagglomerated barium sulfate is variable. Per part by weight of barium sulfate it is possible for there to be in each case up to two parts by weight, preferably up to one part by weight, of crystallization inhibitor and dispersant. Crystallization inhibitor and dispersant are preferably present in an amount of in each case from 1 to 50% by weight in the deagglomerated barium sulfate. The barium sulfate is preferably present in an amount of from 20 to 80% by weight.

It is known that during the conventional preparation of barium sulfate agglomerates (“secondary particles”) are formed from primary particles. The term “deagglomerated” does not mean, in this context, that the secondary particles are disrupted completely into isolated primary particles. It means that the barium sulfate secondary particles are not in the agglomerated state in which they are normally obtained from precipitations, but instead are in the form of smaller agglomerates. The deagglomerated barium sulfate preferably contains agglomerates (secondary particles) of which at least 90% have a particle size smaller than 2 μm, preferably smaller than 1 μm. With particular preference at least 90% of the secondary particles are smaller than 250 nm, very preferably smaller than 200 nm. More preferably still at least 90% of the secondary particles are smaller than 130 nm, being with particular preference smaller than 100 nm and with very particular preference smaller than 80 nm; with still greater preference 90% of the secondary particles have a size of <50 nm, even indeed <30 nm. The barium sulfate here is partly, or even substantially completely, in the form of unagglomerated primary particles. The mean particle sizes in question are those determined by XRD or laser diffraction methods.

Preferred crystallization inhibitors have at least one anionic group. As anionic group the crystallization inhibitor contains preferably at least one sulfate, at least one sulfonate, at least two phosphate, at least two phosphonate, or at least two carboxylate group(s).

As crystallization inhibitor it is possible, for example, for substances known to be used for this purpose to be present, examples being relatively short-chain polyacrylates, customarily in the form of the sodium salt; polyethers such as polyglycol ethers; ether sulfonates such as lauryl ether sulfonate in sodium salt form; esters of phthalic acid and their derivatives; esters of polyglycerol; amines such as triethanolamine; and esters of fatty acids, such as stearic esters, as specified in international patent application WO 01/92157 A.

As crystallization inhibitor it is also possible for a compound of formula V or salt thereof
R²-[A(O)OH]ₚ (V)
to be used. In said formula R² stands for an organic radical having hydrophobic and/or hydrophilic substructures. Preferably R² is a low molecular mass, oligomeric or polymeric, optionally branched and/or cyclic carbon chain, optionally including oxygen, nitrogen, phosphorus or sulfur heteroatoms, and/or is substituted by radicals attached via oxygen, nitrogen, phosphorus or sulfur to the radical R². The variable A stands for C, P(OH), O—P(OH), S(O) or O—S(O). The index p is a number from 1 to 10 000. If the compounds in question are monomeric or oligomeric, p is preferably from 1 to 5.

Useful crystallization inhibitors of this kind include hydroxy-substituted carboxylic acid compounds. For example, hydroxy-substituted monocarboxylic and dicarboxylic acids having from 1 to 20 carbon atoms in the chain (reckoned without the carbon atoms of the COO groups) are very useful, such as citric acid, malic acid (2-hydroxy-1,4-dibutanoic acid), dihydroxysuccinic acid, and 2-hydroxyoleic acid. Also suitable are polyacrylates. Very particular preference is given to citric acid as crystallization inhibitor.

Also highly useful are phosphonic acid compounds having an alkyl (or alkylene) radical with a chain length of from 1 to 10 carbon atoms. Compounds useful in this context are those having one, two or more phosphonic acid radicals. They may additionally be substituted by hydroxyl groups. Useful examples include 1-hydroxythylenediphosphonic acid, 1,1-diphosphonopropane-2,3-dicarboxylic acid, and 2-phosphonobutane-1,2,4-tricarboxylic acid. These examples show that the compounds which can be used include those containing not only phosphonic acid radicals but also carboxylic acid radicals.

Also very useful indeed are compounds containing 1 to 5 or even more nitrogen atoms and also one or more, e.g. up to 5, carboxylic acid or phosphonic acid radicals and being optionally further substituted by hydroxyl groups. Examples of such compounds include those having an ethylenediamine or diethylenetriamine parent structure with carboxylic acid or phosphonic acid substituents. Examples of useful compounds include diethylenetriaminepentakis(methanephosphonic acid), iminodisuccinic acid, diethylenetriaminepentaacetic acid, and N-(2-hydroxyethyl)ethylenediamine-N,N,N-triacetic acid.

Also very useful are polyamino acids—polyaspartic acid, for example.

Also very useful are sulfur-substituted carboxylic acids having 1 to 20 carbon atoms (reckoned without the carbon atoms of the COO group) and one or more carboxylic acid radicals, e.g., di-2-ethylhexyl sulfosuccinate (dioctyl sulfosuccinate).

It will be appreciated that it is also possible to use mixtures of the crystallization inhibitors, including mixtures with further additives such as phosphorous acid, for example.

The barium sulfate intermediate containing crystallization inhibitors and having a mean particle size <50 nm, preferably <30 nm, in particular <20 nm, and very particularly <10 nm, preferably has a BET surface area of at least 30 m²/g, in particular at least 40 m²/g, more preferably at least 45 m²/g, and very preferably at least 50 m²/g.

The preparation of the above-described barium sulfate intermediate with the crystallization inhibitors of the formula V is advantageously conducted by precipitating the barium sulfate in the presence of the crystallization inhibitor provided. It can be advantageous for at least part of the crystallization inhibitor to be deprotonated: for example, by using the crystallization inhibitor entirely, or at least partly, in the form of an alkali metal salt, the sodium salt for example, or in the form of the ammonium salt. Of course, the acid too can be used, with a corresponding amount of the base, or the base in lye form, being added.

Besides the crystallization inhibitor, the deagglomerated barium sulfate also includes an agent having a dispersing activity. The effect of this agent is that no undesirably large agglomerates are formed, if it is added during the actual precipitation. As will be described later on, it can also be added in a subsequent deagglomeration step; it prevents reagglomeration and has the effect that agglomerates are easily redispersed.

The dispersant preferably contains one or more anionic groups which are able to interact with the surface of the barium sulfate. Preferred groups are the carboxylate group, the phosphate group, the phosphonate group, the bisphosphonate group, the sulfate group, and the sulfonate group.

As dispersants it is possible to use some of the above-mentioned agents which in addition to a crystallization-inhibiting effect also exhibit a dispersing activity. Where such agents are used it is possible for crystallization inhibitor and dispersant to be identical. Suitable agents can be determined by means of simple tests. The consequence of using such agents having crystallization-inhibiting and dispersing activity is that the precipitated barium sulfate is obtained in particularly small primary particles, and forms readily redispersible agglomerates. Where such an agent having both crystallization-inhibiting and dispersing activity is used, it can be added at the precipitation stage, and, if desired, a deagglomeration can additionally be conducted in its presence.

It is usual to use different compounds having crystallization-inhibiting or dispersing activity.

Very advantageous is deagglomerated barium sulfate containing dispersants which impart to the barium sulfate particles a surface which, electrostatically, sterically, or both electrostatically and sterically, inhibits agglomeration and/or prevents reagglomeration. Where such a dispersant is present during the actual precipitation, it inhibits the agglomeration of the precipitated barium sulfate, and so barium sulfate deagglomerated during the actual precipitation is obtained. If such a dispersant is incorporated after precipitation, in the course of wet grinding, for example, it prevents the reagglomeration of the deagglomerated barium sulfate following deagglomeration. Barium sulfate containing such a dispersant is especially preferred, since it remains in the deagglomerated state.

One particularly advantageous deagglomerated barium sulfate is characterized in that the dispersant comprises carboxylate, phosphate, phosphonate, bisphosphonate, sulfate or sulfonate groups which are able to interact with the barium sulfate surface and which contains one or more organic radicals R³ which have hydrophobic and/or hydrophilic substructures.

R³ is preferably a low molecular mass, oligomeric or polymeric, optionally branched and/or cyclic carbon chain which optionally contains oxygen, nitrogen, phosphorus or sulfur heteroatoms and/or is substituted by radicals attached via oxygen, nitrogen, phosphorus or sulfur to the radical R³, and the carbon chain is optionally substituted by hydrophilic or hydrophobic radicals. An example of such substituent radicals are polyether groups. Preferred polyether groups have from 3 to 50, more preferably from 3 to 40, and in particular from 3 to 30 alkyleneoxy groups. The alkyleneoxy groups are preferably selected from the group consisting of methyleneoxy, ethyleneoxy, propyleneoxy, and butyleneoxy groups.

Preferred deagglomerated barium sulfate contains a dispersant having groups for attaching to or coupling into polymers. These can be groups which effect this attachment or coupling chemically, e.g., OH groups or NH groups or NH₂ groups. The groups can also be those which effect a physical coupling or attachment.

One example of a dispersant that hydrophobicizes the surface of the barium sulfate is represented by phosphoric acid derivatives in which one oxygen atom of the P(O) group is substituted by a C₃-C₁₀ alkyl or alkenyl radical and another oxygen atom of the P(O) group is substituted by a polyether function. A further acidic oxygen atom of the P(O) group is able to interact with the barium sulfate surface.

The dispersant can be, for example, a phosphoric diester whose substructures include a polyether group and a C₆-C₁₀ alkenyl group.

A deagglomerated barium sulfate having especially good properties contains as dispersant a polymer which has anionic groups able to interact with the surface of the barium sulfate, examples being the groups mentioned above, and is substituted by polar groups, e.g., by hydroxyl or amino groups. Contained with preference are polyether groups substituted terminally by hydroxyl groups. As a result of this substitution the barium sulfate particles are externally hydrophilicized. Deagglomerated barium sulfate of this kind shows no tendency to reagglomerate. There may even be further deagglomeration in the course of use. The polar groups, especially hydroxyl and amino groups, represent reactive groups suitable for attaching to or coupling into epoxy resins in particular. Especially good properties are possessed by a deagglomerated barium sulfate coated with a dispersant having a multiplicity of polycarboxylate groups and a multiplicity of hydroxyl groups and also further substituents which are bulky, polyether groups for example. One very preferred group of dispersants are polyetherpolycarboxylates substituted terminally on the polyether groups by hydroxyl groups.

Deagglomerated barium sulfate of this kind, containing a crystallization inhibitor and one of the particularly preferred dispersants which prevent reagglomeration sterically, especially a dispersant substituted by polar groups as described above, has the great advantage that it comprises very fine primary particles and also secondary particles with a very low level of agglomeration, if any, which, because they are readily redispersible, have very good application properties, for example, can be incorporated effectively into polymers and do not tend to reagglomerate, and in fact even undergo further deagglomeration in the course of use.

In accordance with one embodiment the deagglomerated, coated barium sulfate is in dry form. In accordance with another embodiment it is in the form of a suspension in water or in the form of a suspension in an organic liquid, which organic liquid may optionally also contain water. Preferred organic liquids are naphtha, special boiling point spirit or alcohols such as isopropanol. Within the suspension the deagglomerated barium sulfate is present in an amount of preferably from 0.1 to 60% by weight, more preferably from 0.1 to 25% by weight, or very preferably from 1 to 20% by weight.

The deagglomerated barium sulfate and in particular its suspension, especially a water-based suspension, may further comprise modifiers which influence its properties. The additional modifier, where present, preferably has a smaller hydrodynamic volume than the compound used as dispersant. The modifier is preferably of low molecular mass; in particular it contains at least one, especially one, of the anionic groups described above. Examples of especially suitable modifiers include organic acids, preferably acetic acid and propionic acid, especially acetic acid. It has been found that suspensions of the deagglomerated barium sulfate, especially aqueous suspensions, which comprise organic acid are particularly stable toward sedimentation.

With advantage the deagglomerated barium sulfate is also of an average primary particle size <50 nm, preferably <20 nm, and is substantially agglomerate-free: that is, the average secondary particle size is not more than 30% greater than the average primary particle size.

The deagglomerated barium sulfate can be prepared according to different variants.

The first variant envisages precipitating barium sulfate in the presence of a crystallization inhibitor and subsequently carrying out a deagglomeration. This deagglomeration is carried out in the presence of a dispersant.

The second variant envisages precipitating barium sulfate in the presence of a crystallization inhibitor and of a dispersant.

The first variant will now be illustrated further.

Barium sulfate is precipitated in accordance with customary methods: for example, by reacting barium chloride or barium hydroxide with alkali metal sulfate or sulfuric acid. This is done using processes in which primary particles having the fineness indicated above are formed. At the precipitation stage additives are employed which inhibit the crystallization, examples being those as specified in international patent application WO 01/92157 A, or the above-mentioned compounds of the formula V which exhibit crystallization-inhibiting activity. The precipitated barium sulfate is dewatered, if desired, to the paste state or even to that of the dry powder. A wet deagglomeration follows. The liquid chosen can be water or an organic liquid, an alcohol for example. The deagglomeration, which is conducted in, for example, a bead mill, then takes place in the presence of a dispersant. The dispersants have been specified above; it is possible, for example, to use an agent of the formula (I) which has dispersing properties. In this case the crystallization inhibitor and the dispersant may be the same. During precipitation it is the crystallization-inhibiting activity which is exploited; during deaggomeration, the dispersing activity. For the deagglomeration it is preferred to use those dispersants which prevent reagglomeration sterically, particularly those dispersants substituted by hydroxyl groups. The grinding and hence the deagglomeration are continued until the desired degree of deagglomeration has been reached. Deagglomeration is preferably continued until the deagglomerated barium sulfate of the invention contains secondary particles of which 90% are smaller than 2 μm, preferably smaller than 1 μm, more preferably smaller than 250 μm, and very preferably smaller than 200 nm. Deagglomeration is continued more preferably still until 90% of the secondary particles are smaller than 130 nm, more preferably smaller than 100 nm, very preferably smaller than 80 nm, and more preferably still <50 nm. The barium sulfate here can be present partly or even substantially completely in the form of unagglomerated primary particles (mean particle sizes, determined by XRD or laser diffraction methods). The suspension of the deagglomerated barium sulfate formed during wet agglomeration, comprising a crystallization inhibitor and a dispersant, can then be used as it is, for incorporation into plastics, for example.

As described above, it is also possible to produce a storage-stable suspension by adding acid.

Drying can also be performed, spray drying for example. The particles formed here very readily break back down into the deagglomerated barium sulfate. The barium sulfate of the invention is formed from very small primary particles and is redispersible; the secondary particles are in a deagglomerated state.

The second variant of the invention envisages conducting the precipitation, by reaction, for example, of barium chloride or barium hydroxide with alkali metal sulfate or sulfuric acid, in the presence of a crystallization inhibitor and of a dispersant; this procedure leads to readily redispersible deagglomerated barium sulfate being formed during the actual precipitation. Dispersants of this kind, which impart to the barium sulfate particles a surface which inhibits agglomeration during precipitation and prevents reagglomeration electrostatically, sterically, or both electrostatically and sterically, have been elucidated earlier on above. With this embodiment, deagglomerated barium sulfate is produced during the actual precipitation.

The precipitated barium sulfate containing crystallization inhibitor and dispersant is in principle ready for service and can be used as an aqueous suspension. As described above, additionally stabilizing the suspension with acid is a possibility. The precipitated deagglomerated barium sulfate can also be partly or wholly dewatered, by spray drying for example. A paste or powder is then formed. The powder, of course, contains agglomerates. These agglomerates, however, are not agglomerated in the same way as in prior art barium sulfate, but instead are relatively loose aggregates which are redispersible in liquid media, when they again form deagglomerated particles. Alternatively the powder can be converted into a suspension, with addition of water or organic liquids; in this case too, the deagglomerated particles such as were present before drying are obtained again. A suspension in a polymeric premix, which then comprises the deagglomerated barium sulfate, is also suitable. In many applications it is unnecessary to disrupt the dried agglomerates or to convert them into a suspension prior to use, since in the course of use they are transformed into the deagglomerated particles—for example, when they are incorporated into liquid precursors. If the especially preferred polymeric dispersants are used which prevent reagglomeration sterically and have polar groups for attachment to or coupling into polymers, further deagglomeration is in fact observed.

The deagglomerated barium sulfate, in the form of a readily redispersible powder, or else if desired in the form of an aqueous suspension or in the form of a suspension in an organic liquid, can be used for all purposes for which barium sulfate is customarily used. It is especially suitable for addition to curable compositions and cured compositions, which include, among others, adhesives and sealants.

Surprisingly the deagglomerated barium sulfate is able to serve as catalyst for the curing of the curable compositions of the invention, preferably of the curable compositions of the invention containing epoxide groups.

The amount of deagglomerated barium sulfate in the curable compositions of the invention can vary very widely and is guided by the requirements of the case in hand. The amount is preferably from 0.05 to 10%, more preferably from 0.05 to 8%, and in particular from 0.05 to 6% by weight, based in each case on the solids of the curable compositions of the invention.

The solids content of the curable compositions of the invention, i.e., the amount of constituents which make up the cured compositions of the invention produced from the curable compositions of the invention, may vary very widely and is guided by the requirements of the case in hand. The solids content is preferably from 20 to 80%, more preferably from 30 to 70%, and in particular from 30 to 60% by weight, based in each case on the curable composition of the invention.

Besides the above-described deagglomerated barium sulfate the curable compositions of the invention preferably comprise at least one curable binder (A) selected from the group consisting of low molecular mass compounds, oligomers, and polymers, preferably oligomers and polymers.

The amount of binders (A) in the curable compositions of the invention may vary very widely and is also guided by the requirements of the case in hand. The amount is preferably from 50 to 99.9%, more preferably from 60 to 99.9%, and in particular from 70 to 99.9% by weight, based in each case on the solids of the curable composition of the invention.

The curable binders (A) of low molecular mass preferably comprise epoxy-functional silanes, such as are known, for example, from patent applications EP 1 179 575 A2, WO 00/35599 A, WO 99/52964 A, WO 99/54412 A, DE 197 26 829 A1 or DE 195 40 623 A1, especially glycidyloxypropyltrimethoxysilane or glycidyloxypropyltriethoxysilane, and/or silanes containing at least one olefinically unsaturated group, especially a vinyl group or a methacrylate or acrylate group, such as are known, for example, from patent applications WO 00/22052 A, WO 99/54412 A, DE 199 10 876 A1 or DE 197 19 948 A1, particularly the monomers (a2) described below.

It is also possible to use the hydrolysates and/or condensates of these low molecular mass compounds as binders (A).

The hydrolysates and/or condensates (A) are preparable by condensing the low molecular mass binders (A), preferably in the context of what is known as the sol-gel process. The basic reactions of this process can be illustrated by reference to the tetraorthosilicates. These are hydrolyzed and condensed in the presence where appropriate of a cosolvent:

Hydrolysis
Si(OR′)₄+H₂O→(R′O)₃Si—OH+R′OH
Condensation
—Si—OH+HO—Si—→—Si—O—Si—+H₂O
—Si—OH+R′O—Si—→—Si—O—Si—+R′OH,
where R′ can be an alkyl group, such as methyl or ethyl. The reactions are catalyzed using acids, bases or fluoride ions.

The curable polymers and oligomers (A) contain at least one reactive functional group (a1) and preferably at least two and in particular at least three reactive functional groups (a1) which render the oligomers and polymers (A) curable thermally and/or with actinic radiation. Examples of suitable reactive functional groups (a1) are known from international patent application WO 03/016411 A, page 10 line 20 to page 12 line 2 and page 20 line 1 to page 22 line 16. Epoxide groups (a1) are used in particular.

The oligomers and polymers (A) are preferably hydrolysates and/or condensates preparable by hydrolyzing and/or condensing oligomers and/or polymers (A) containing epoxide groups (a1) and hydrolyzable silane groups (a2).

The oligomers and/or polymers (A) containing epoxide groups (a1) and hydrolyzable silane groups (a2) can also be used, however, as curable constituents (A).

The hydrolysates and/or condensates (A) are preparable by condensing oligomers and/or polymers (A) containing epoxide groups and hydrolyzable silane groups (a2), preferably in what is called the sol-gel process, whose basic reactions are described above.

The oligomers (A) contain on average more than 2 and not more than 15 incorporated monomer units. In general the polymers (A) contain more than 10, preferably more than 15, incorporated monomer units.

The hydrolysates and/or condensates (A) are preparable in each case from at least one, especially one, oligomer (A) or polymer (A) containing hydrolyzable silane groups (a2). For particular applications, however, it is also possible to use mixtures of at least two different oligomers (A), polymers (A), or oligomers and polymers (A) containing hydrolyzable silane groups (a2).

The oligomers and polymers (A) containing hydrolyzable silane groups (a2) contain in each case at least one epoxide group (a1) and at least one silane group (a2) which is hydrolyzable in the aforementioned sense. They preferably contain on average at least two, in particular at least three, epoxide groups (a1) and at least two, in particular at least three, hydrolyzable silane groups (a2). The groups in question can be terminal and/or lateral epoxide groups (a1) and hydrolyzable silane groups (a2).

The oligomers and polymers (A) containing hydrolyzable silane groups (a2) can have a linear, star-shaped, dendrimeric or comb structure. Within an oligomer or polymer (A) containing hydrolyzable silane groups (a2) these structures may be present in combination with one another. In that case the monomer units can be distributed randomly, in alternation or in blocks, it being possible for these distributions to be present in combination with one another within an oligomer or polymer (A) containing hydrolyzable silane groups (a2).

The number-average and mass-average molecular weights and the polydispersity of the molecular weight of the oligomers and polymers (A′) may vary widely and are guided by the requirements of the case in hand. The number-average molecular weight (determined by gel permeation chromatography using polystyrene as internal standard) is preferably from 800 to 3000, more preferably from 1000 to 2500, and in particular from 1000 to 2000 daltons. The mass-average molecular weight is preferably from 1000 to 8000, more preferably from 1500 to 6500, and in particular from 1500 to 6000 daltons. The polydispersity is preferably <10, more preferably <8, and in particular <5.

The oligomers and polymers (A) containing hydrolyzable silane groups (a2) can come from any of the polymer classes in whose preparation, and thereafter, the epoxide groups (a1) and the hydrolyzable silane groups (a2) are not reacted. The skilled worker is therefore able to select the appropriate polymer classes easily on the basis of his or her general art knowledge. The oligomers and polymers (A) containing hydrolyzable silane groups (a2) are preferably addition polymers, particularly addition copolymers of olefinically unsaturated monomers.

The epoxide groups (a1) are bonded covalently via linking organic groups (G1) to the main chain or chains of the oligomers and polymers (A) containing hydrolyzable silane groups (a2). Here it is possible for one epoxide group (a1) to be linked to the main chain via a divalent linking organic group (G1) or for at least two epoxide groups (a1) to be linked to the main chain via an at least trivalent linking organic group (G1). With preference one epoxide group (a1) is linked to the main chain via a divalent linking organic group (G1).

The divalent linking organic groups (G1) preferably contain at least one, especially one, at least divalent, especially divalent, group (G11) selected from the group consisting of substituted and unsubstituted, preferably unsubstituted, branched and unbranched, preferably unbranched, cyclic and noncyclic, preferably noncyclic, alkyl, alkenyl, and alkynyl groups, especially alkyl groups, and also substituted and unsubstituted, preferably unsubstituted, allyl groups, or consist thereof.

In particular the divalent group (G11) is an unbranched, noncyclic, unsubstituted, divalent alkyl group having 1 to 10, preferably 2 to 6, and in particular 1 to 4 carbon atoms, such as a methylene, ethylene, trimethylene or tetramethylene group.

The divalent linking organic groups (G1) preferably further include at least one, especially one, at least divalent, especially divalent, linking functional group (G12), preferably selected from the group consisting of ether, thioether, carboxylate, thiocarboxylate, carbonate, thiocarbonate, phosphate, thiophosphate, phosphonate, thiophosphonate, phosphite, thiophosphite, sulfonate, amide, amine, thioamide, phosphoramide, thiophosphoramide, phosphonamide, thiophosphonamide, sulfonamide, imide, hydrazide, urethane, urea, thiourea, carbonyl, thiocarbonyl, sulfone or sulfoxide groups, especially carboxylate groups.

Examples of suitable substituents are halogen atoms, especially fluorine atoms and chlorine atoms, nitrile groups, nitro groups or alkoxy groups.

The above-described groups (G1) and (G11) are preferably unsubstituted.

The epoxide groups (a1) are connected to the main chain via a group (G11) which in turn is connected thereto via a group (G12), with particular preference in accordance with the general formula I:
-(-G12-)-(G11-)-epoxide (I).

In particular
—C(O)—O—CH₂-epoxide (I1)
is used as group of the general formula I.

The hydrolyzable silane groups (a2) can have different structures. They are preferably selected from the group consisting of hydrolyzable silane groups (a2) of the general formula II:
—SiRₘR¹ₙ (II).

In the general formula II the meaning of the indices and variables is as follows:
R is a monovalent hydrolyzable atom or monovalent hydrolyzable group;
R¹ is a monovalent nonhydrolyzable radical;
m is an integer from 1 to 3, preferably 3, and
n is 0 or 1 or 2, preferably 0 or 1,
   with the proviso that m+n=3.

Examples of suitable monovalent hydrolyzable atoms R are hydrogen, fluorine, chlorine, bromine, and iodine.

Examples of suitable monovalent hydrolyzable radicals R are hydroxyl groups, amino groups —NH₂, and groups of the general formula III:
R¹—X— (III)
in which the variables have the following meanings:
X is an oxygen atom, sulfur atom, carbonyl group, thiocarbonyl group, carboxyl group, thiocarboxylic S-ester group, thiocarboxylic O-ester group or amino group —NH— or —NR¹—, preferably oxygen atom; and
R¹ is a monovalent organic radical.

The monovalent organic radical R¹ contains at least one group (G2) selected from the group consisting of substituted and unsubstituted, preferably unsubstituted, branched and unbranched, preferably unbranched, cyclic and noncyclic, preferably noncyclic, alkyl, alkenyl, and alkynyl groups, preferably alkyl groups, and also substituted and unsubstituted aryl groups; in particular unsubstituted, unbranched, noncyclic alkyl groups; or consists thereof.

Examples of suitable substituents are those mentioned above.

Where the radical R¹ consists of a group (G2) it is monovalent.

Where the radical R¹ comprises a group (G2) it is at least divalent, in particular divalent, and linked directly to —X—. Additionally the radical R¹ may contain at least one, especially one, of the groups (G12) described above.

Where the radical R¹ contains at least two groups (G2) at least one of them is at least divalent, especially divalent, and linked directly to —X—. This group (G2) linked directly to —X— is linked to at least one further group (G2). This group (G2) linked directly to —X— is preferably linked to the further group (G2) via a group (G12) or with the further groups (G2) via at least two groups (G12).

With preference the radical R¹ consists of a group (G2). In particular the radical R¹ is selected from the group consisting of methyl, ethyl, propyl, and butyl.

The hydrolyzable silane groups (a2) are selected in particular from the group consisting of trimethoxysilyl, triethoxysilyl, tripropoxysilyl, and tributoxysilyl, especially trimethoxysilyl and triethoxysilyl.

The hydrolyzable silane groups (a2) are bonded covalently to the main chain or chains of the oligomers and polymers (A) preferably via the linking organic groups (G1) described above. In this context it is possible for one hydrolyzable silane group (a2) to be linked to the main chain via a divalent linking organic group (G1) or for at least two hydrolyzable silane groups (a2) to be linked to the main chain via an at least trivalent linking organic group (G1). Preferably one hydrolyzable silane group (a2) is linked to the main chain via a divalent linking organic group (G1).

Here again, preferably, the monovalent linking organic groups (G1) comprise or consist of at least one, especially one, of the above-described at least divalent, especially divalent, groups (G11). More preferably the divalent linking organic groups (G1) additionally contain at least one, especially one, of the above-described at least divalent, especially divalent, linking functional groups (G12).

With preference the silane groups (a2) are linked to the main chain of the oligomers and polymers (A) via a divalent linking group (G11) which is in turn so linked via a divalent linking functional group (G12), in accordance with the general formula (IV):
-(-G12-)-(G11-)-SiRₘR¹ₙ (IV)
in which the indices and variables have the meanings indicated above. Very particular preference is given to using the following groups of the general formula IV:
—C(O)—O—(—CH₂—)₂—Si(OCH₃)₃ (IV1),
—C(O)—O—(—CH₂—)₃—Si(OCH₃)₃ (IV2),
—C(O)—O—(—CH₂—)₂—Si(OC₂H₅)₃ (IV3)
—C(O)—O—(—CH₂—)₃—Si(OC₂H₅)₃ (IV4),
—C(O)—O—CH₂—Si(OC₂H₅)₃ (IV5)
and
—C(O)—O—CH₂—SiCH₃(OC₂H₅)₂ (IV6),
especially (IV4).

The molar ratio of epoxide groups (a1) to hydrolyzable silane groups (a2) in the oligomers and polymers (A′) may vary widely. It is preferably from 1.5:1 to 1:1.5, more preferably from 1.3:1 to 1:1.3, and in particular from 1.1:1 to 1:1.1.

With very particular advantage the (meth)acrylate copolymers (A), the lateral and/or terminal epoxide groups (a1) and lateral and/or terminal, hydrolyzable silane groups (a2) of the general formula II:
—SiRₘR¹ₙ (II)
in which the indices and the variables have the definitions indicated above, are present in a molar ratio (a1):(a2) of from 1.5:1 to 1:1.5, preferably from 1.3:1 to 1:1.3, and in particular from 1.1:1 to 1:1.1. These (meth)acrylate copolymers (A′) of the invention yield especially advantageous hydrolyzates and/or condensates (A).

In addition to the above-described epoxide groups (a1) and silane groups (a2) the oligomers and polymers (A) may additionally contain further lateral and/or terminal groups (a3). It is essential that the groups (a3) neither react with the epoxide groups (a1) and silane groups (a2) nor disrupt the progress of the condensation. Examples of suitable groups (a3) are fluorine atoms, chlorine atoms, nitrile groups, nitro groups, alkoxy groups, polyoxyalkylene groups or the monovalent organic radicals R¹ described above, especially aryl groups, alkyl groups, and cycloalkyl groups. Using these groups (a3) it is possible to vary broadly the profile of properties of the oligomers and polymers (A) containing hydrolyzable silane groups (a2), and hence of the hydrolyzates and/or condensates (A), in an advantageous way.

The oligomers and polymers (A) containing hydrolyzable silane groups (a2) are preparable by copolymerizing at least one, especially one, monomer (a1) containing at least one, especially one, epoxide group (a1) with at least one, especially one, monomer (a2) containing at least one, especially one, silane group (a2). The monomers (a1) and (a2) may additionally be copolymerized with at least one monomer (a3) containing at least one group (a3).

Particular advantages result if the monomers (a1) and (a2) are copolymerized with one another in a molar ratio (a1):(a2) of from 1.5:1 to 1:1.5, preferably from 1.3:1 to 1:1.3, and in particular from 1.1:1 to 1:1.1. Very particular advantages are obtained if this results in the above-described molar ratio of epoxide groups (a1) to hydrolyzable silane groups (a2) in the oligomers and polymers (A′).

The monomers (a1), (a2), and (a3) preferably contain at least one, especially one, olefinically unsaturated group.

Examples of suitable olefinically unsaturated groups are (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups, preferably methacrylate groups and acrylate groups, in particular methacrylate groups.

One example of an especially suitable monomer (a1) is glycidyl methacrylate.

One example of an especially suitable monomer (a2) is methacryloyloxypropyltrimethoxysilane (MPTS), sold under the brand name Dynasilan® MEMO by Degussa, or methacryloyloxymethyltriethoxysilane or methacryloyloxymethylmethyldiethoxysilane, sold under the brand names Geniosil® XL 34 and Geniosil® XL 36 by Wacker.

Examples of suitable monomers (a3) are described in international patent application WO 03/016411, page 24 line 9 to page 28 line 8.

The oligomers and polymers (A′) are preferably preparable in conventional manner by free-radical copolymerization of the monomers (a1) and (a2) and also, where appropriate, (a3), preferably without solvent or in solution, in particular in solution.

The hydrolyzates and/or condensates (A) are preferably prepared by condensing the above-described oligomers and/or polymers (A) containing hydrolyzable silane groups (a2), preferably at a pH <7. The hydrolysis and/or condensation takes place in a sol-gel process by reaction with water in the presence of an organic or inorganic acid, preferably an organic acid, particularly formic acid or acetic acid. The condensation is conducted at preferably from −10 to +80° C., more preferably from 0 to +80° C., and in particular from +10 to +75° C.

The hydrolysis and/or condensation can be conducted in the presence of conventional, hydrolyzable silanes of low molecular mass, which are different from the low molecular mass compounds (A), and/or hydrolyzable metal alkoxides, as described, for example, in German patent application DE 199 40 857 A1, of the deagglomerated barium sulfate nanoparticles (N) and/or of nanoparticles different from these.

The hydrolysates and/or condensates (A) can be processed further in solution or dispersion form or else used directly as curable compositions of the invention. Before their further processing to the curable compositions of the invention they are preferably freed largely from water and/or organic solvents.

As catalysts it is possible to add to the hydrolysates and/or condensates (A) and/or to the curable compositions of the invention compounds of metals with at least one organic, preferably nonaromatic, compound which is able to form chelate ligands. The compounds which form chelate ligands are organic compounds having at least two functional groups which are able to coordinate to metal atoms or metal ions. These functional groups are usually electron donors, which donate electrons to metal atoms or metal ions as electron acceptors. Suitable in principle are all organic compounds of the type stated, provided that they do not adversely affect, let alone prevent entirely, the crosslinking of the curable compositions of the invention to form cured compositions of the invention. Examples of suitable organic compounds are dimethylglyoxime or compounds containing carbonyl groups in positions 1 and 3, such as acetylacetone or ethyl acetoacetate. For further details refer to Römpp Chemie Lexikon, Georg Thieme Verlag, Stuttgart, 1989, Volume 1, page 634. Aluminum chelate complexes in particular were used as catalysts.

The hydrolysates and/or condensates (A) and/or the curable compositions of the invention may further be admixed with conventional catalysts for the crosslinking of the epoxide groups, such as Lewis acids, aluminum compounds or tin compounds of amines or heterocycles, such as are described in, for example, the book by Bryan Ellis, “Chemistry and Technology of Epoxy Resins”, University of Sheffield, Blackie Academic & Professional.

They may also be admixed with conventional constituents typical for coating materials. Examples of suitable constituents are described in, for example, international patent application WO 03/016411, page 14 line 9 to page 35 line 31.

The preparation of the curable compositions of the invention has no peculiarities in terms of method but can instead be carried out with the aid of the apparatus and techniques described in international patent application WO 03/016411, page 36 lines 13 to 20.

The curable compositions of the invention include conventional organic solvents (cf. international patent application WO 03/016411, page 35 lines 12 to 14) and also, preferably, water. It is a particular advantage of the liquid curable compositions of the invention that they can have a solids content >30% by weight without detriment thereby to their very good transportability, storage stability, and processing properties, in particular their application properties.

The curable compositions of the invention serve for producing the cured compositions of the invention. They are preferably used as pigmented and unpigmented coating materials, especially clearcoat materials, and also as starting materials for moldings, especially optical moldings, and self-supporting sheets.

The cured compositions of the invention are preferably pigmented and unpigmented coatings and paint systems of high scratch resistance, more preferably transparent, especially clear, clearcoats, moldings, especially optical moldings, and self-supporting sheets. With very particular preference the cured compositions of the invention are highly scratch-resistant clearcoats, including highly scratch-resistant clearcoats as part of multicoat color and/or effect paint systems on conventional substrates (cf. in this respect international patent application WO 03/016411, page 41 line 6 to page 43 line 6 in conjunction with page 44 line 6 to page 45 line 6).

The production of the cured compositions of the invention from the curable compositions of the invention has no peculariarties in terms of method but is instead accomplished by means of conventional techniques and apparatus which are typical for the cured composition of the invention in question.

In particular the curable coating materials of the invention are applied to substrates by means of the conventional techniques and apparatus described in international patent application WO 03/016411, page 37 lines 4 to 24.

The curable compositions of the invention can be cured as described in international patent application WO 03/016411, page 38 line 1 to page 41 line 4.

The curable compositions of the invention provide new cured compositions, particularly coatings and paint systems, especially clearcoats, moldings, especially optical moldings, and self-supporting sheets which are highly scratch-resistant and chemically stable. The coatings and paint systems of the invention, especially the clearcoats, can be produced even in thicknesses >40 μm without stress cracks occurring.

The cured compositions of the invention are therefore outstandingly suitable for use as highly scratch-resistant, decorative, protective and/or effect-imparting coatings and paint systems on bodies of means of transport of any kind (especially means of transport operated by muscle power, such as cycles, coaches or railroad trollies, aircraft, such as airplanes, helicopters or airships, floating structures, such as ships or buoys, rail vehicles and motor vehicles, such as locomotives, railcars, railroad wagons, motorcycles, buses, trucks or automobiles) or on parts thereof; on the interior and exterior of buildings; on furniture, windows and doors; on polymeric moldings, especially those of polycarbonate, particularly CDs and windows, especially automobile windows; on small industrial parts, on coils, containers, and packaging; on white goods; on sheets; on optical, electrical, and mechanical components, and also on hollow glassware and articles of everyday use.

The coatings and paint systems of the invention, especially the clearcoats, can be employed in particular in the technologically and esthetically particularly demanding field of automotive OEM finishing. There they are notable particularly for especially high carwash resistance and scratch resistance.

### EXAMPLES

### Preparation Example 1

The Preparation of a Condensate (A)

A three-necked glass flask equipped with stirrer, reflux condenser, gas inlet, and two feed vessels was charged with 534.63 parts by weight of ethoxypropanol and 59.37 parts by weight of propyl glycol. This initial charge was heated to 133° C. under nitrogen and with stirring. Thereafter the first feed stream, consisting of 380.26 parts by weight of glycidyl methacrylate and 664.27 parts by weight of methacryloyloxypropyltrimethoxysilane, and the second feed stream, consisting of 169.64 parts by weight of tert-butyl peroxy-2-ethylhexanoate, 172.64 parts by weight of ethoxypropanol, and 19.18 parts by weight of propyl glycol, were metered slowly into the initial charge, beginning at the same time, and with stirring. The first feed stream was metered in over the course of two hours and the second over the course of five hours. The resultant reaction mixture was subsequently polymerized with stirring at 130° C. for 1.5 hours. The resultant methacrylate copolymer (A′) had a residual monomer content below the gas chromatography detection limit.

To 102.8 parts by weight of the methacrylate copolymer (A′) there were added 184.3 parts by weight of isopropanol, 171.3 parts by weight of 2N formic acid, and 46.3 parts by weight of deionized water. The resultant reaction mixture was stirred at 70° C. for an hour and then 95.4 parts by weight of ethoxypropanol were added. Subsequently the low-boiling constituents were distilled off under reduced pressure at a maximum temperature of 70° C.

### Preparation Example 2

Preparation of Barium Sulfate by Precipitation in the Presence of Crystallization Inhibitors and Polymeric Dispersants During the Precipitation

The starting materials used were barium chloride and sodium sulfate.

2.1 Laboratory Experiment:

A 200 ml graduated flask was charged with 7.77 g of the Melpers-type, terminally hydroxy-substituted polyetherpolycarboxylate (Melpers® 0030) from SKW and filled to 200 ml with water. This quantity corresponded to 50% of Melpers® (w=30%), based on the maximum amount of BaSO₄ formed (=4.67 g).

A 600 ml-high glass beaker was charged with 50 ml of 0.4M BaCl₂ solution, to which 200 ml of the Melpers® solution were added. To aid dispersion an Ultraturrax was immersed centrally into the glass beaker and operated at 5000 rpm. Within the vortex created by the Ultraturrax 50 ml of 0.4M Na₂SO₄ solution to which citric acid had been added (50% of citric acid, based on the maximum amount of BaSO₄ formed=2.33 g per 50 ml/Na₂SO₄) were added via a hose, using a Dosimat. Both the BaCl₂/Melpers® solution and the Na₂SO₄/citric acid solution were rendered alkaline using NaOH prior to precipitation; the pH was approximately 11-12.

The resulting barium sulfate, obtained in deagglomerated form, possessed a primary particle size of approximately 10 to 20 nm; the secondary particle size was situated within the same range, and so the sulfate could be regarded as largely free of agglomerates.

2.2 Preparation of Deagglomerated Barium Sulfate on the Pilot Plant Scale:

A 30 L vessel was charged with 5 L of a 0.4M BaCl₂ solution. 780 g of the Melpers® product were added with stirring (50%, based on maximum amount of BaSO₄ formed=467 g). To this solution there were added 20 L of demineralized water. Operated within the vessel was an Ultraturrax, in whose vortex region 5 L of 0.4M Na₂SO₄ solution were added via a stainless steel pipe, using a peristaltic pump. Citric acid had been added to the Na₂SO₄ solution beforehand (233 g/5 L Na₂SO₄=50% of citric acid, based on maximum amount of BaSO₄ formed). As in the case of the laboratory experiments, both solutions had been rendered alkaline by means of NaOH prior to precipitation in these experiments as well. The properties in respect of primary particle size and serviceability corresponded to those of the barium sulfate from preparation example 2.1. The sulfate was likewise largely free from agglomerates.

### Preparation Example 3

Preparation of a Stabilized Suspension Containing 16% by Weight Barium Sulfate

An approximately 1%, aqueous suspension (colloidal solution) of the deagglomerated barium sulfate prepared in accordance with example 1.2 was first adjusted to a pH of 6 using 0.5 N acetic acid. Subsequently 10% by weight of a 0.5% strength ammonia solution were added, so that the resulting pH was 10. Thereafter the preparation was concentrated further on a rotary evaporator until a solids content of 16% by weight was reached. The resultant solution was stable for more than one week at room temperature and could be used for preparing curable compositions.

### Preparation Example 4

Preparation of a Stabilized Suspension Containing 10% by Weight Barium Sulfate

Preparation example 3 was repeated analogously but the suspension was concentrated only to a barium sulfate content of 10% by weight.

The suspension was stable for three weeks. The hydrodynamic volume of the deagglomerated barium sulfate was determined by means of dynamic light scattering (PCS). This indicated a hydrodynamic radius of 24 nm. Taking into account the influence of the surface modification and of the hydrate shell, the resulting particle size of the actual barium sulfate nanoparticles was 20 nm.

### Examples 1 to 3 (Inventive) and C1 (Comparative)

The Preparation of Clearcoat Materials 1 to 3 and C1 and Production of Clearcoats 1 to 3 and C1

Clearcoat materials 1 to 3 and C1 were prepared by mixing the constituents indicated in table 1 and homogenizing the resulting mixtures. All four clearcoat materials were transparent and clear, transportable and stable on storage.

Clearcoat materials 1 to 3 and C1 were knifecoated onto glass panels and cured thermally at 140° C. for 22 minutes. Thermal curing was carried out using forced air ovens from Heraeus.

This gave high-gloss, clear clearcoats 1 to 3 and C1 which exhibited very good leveling and were free from stress cracks and surface defects such as craters. Their scratch resistance was determined by means of the steel wool scratch test.

The steel wool scratch test was conducted using a hammer in accordance with DIN 1041 (weight without shaft: 800 g; shaft length: 35 cm). Prior to the test the panels were stored at room temperature for 24 hours.

The flat side of the hammer was wrapped with a ply of steel wool and fastened at the raised sides using tesakrepp tape. The hammer was placed at right angles on the clearcoats. The head of the hammer was guided, without tipping and without additional physical force, in a track over the surface of the clearcoat.

For each test, 10 strokes back and forth were executed by hand. After each of these individual tests the steel wool was replaced.

Following exposure, the test areas were cleaned of the residues of steel wool using a soft cloth. The areas under test were evaluated visually under artificial light and rated as follows:

| Rating | Damage |
|---|---|
| 1 | none |
| 2 | slight |
| 3 | moderate |
| 4 | moderate to medium |
| 5 | severe |
| 6 | very severe |

Evaluation took place immediately after the end of the test. The results are likewise given in table 1.

TABLE 1
The physical composition of clearcoat materials 1 to 3 and
C1 and the scratch resistance of clearcoats 1 to 3 and C1

| | Parts by weight in the clearcoat | | | |
|---|---|---|---|---|
| | material: | | | |
| | 1 | 2 | 3 | C1 |
| Ingredient | | | | |
| Condensate (A) from | 5 | 5 | 5 | 5 |
| preparation example 1 | | | | |
| 1% strength by weight aqueous | 0.5 | 0.75 | 0.5 | — |
| solution of deagglomerated | | | | |
| barium sulfate from | | | | |
| preparation example 2 | | | | |
| 1% strength by weight solution | — | — | 0.11 | — |
| of methylimidazole in propyl | | | | |
| glycol | | | | |
| Leveling agent (Byk ® 301 from | 0.6 | 0.6 | 0.6 | 0.6 |
| Byk Chemie) | | | | |
| Clearcoat: | | | | |
| Steel wool scratch test (rating) | 2 | 2 | 1 | 5 |

The results underline the high scratch resistance of clearcoats 1 to 3. It is surprising that the high scratch resistance was obtainable even with very small amounts of deagglomerated barium sulfate, in the order of magnitude of from 0.1 to 0.15% by weight, based on the solids.

### Examples 4 (Inventive) and C2 (Comparative)

The Preparation of Clearcoat Materials 4 and C2 and Production of Clearcoats 4 and C2

Clearcoat materials 4 and C2 were prepared by mixing the ingredients indicated in table 2 and homogenizing the resultant mixtures. The two clearcoat materials were transparent and clear, transportable and stable on storage.

Clearcoat materials 4 and C2 were knifecoated onto glass panels and cured thermally at 140° C. for 22 minutes. Thermal curing was carried out using forced air ovens from Heraeus.

High-gloss, clear clearcoats 4 and C2 were obtained which exhibited very good leveling and were free from stress cracks and surface defects such as craters. Their scratch resistance was determined by means of the steel wool scratch test and by means of the relative elastic resilience (Fischerscope), which correlates very well with the carwash resistance.

The results are likewise given in table 2. They again underline the fact that the use of the deagglomerated barium sulfate, even in small amounts, leads to a significant increase in scratch resistance and carwash resistance.

TABLE 2
The physical composition of clearcoat materials 4 and
C2 and the scratch resistance of clearcoats 4 and C2

| | Parts by weight in the clearcoat | |
|---|---|---|
| | material: | |
| | 4 | C2 |
| Ingredient | | |
| Condensate (A) from | 3 | 5 |
| preparation example 1 | | |
| 10% strength by weight aqueous | 0.5 | — |
| solution of deagglomerated | | |
| barium sulfate from | | |
| preparation example 4 | | |
| Leveling agent (Byk ® 301 from | 0.6 | 0.6 |
| Byk Chemie) | | |
| Clearcoat: | | |
| Steel wool scratch test (rating) | 5 | 2 |
| Relative elastic resilience (%) | 54.75 | 61.12 |

1. A curable composition comprising deagglomerated barium sulfate containing at least one dispersant, and at least one crystallization inhibitor and has a primary particle size of <0.5 μm.

2. The curable composition as claimed in claim 1, wherein the crystallization inhibitor is selected from the group consisting of compounds of the general formula V or salts thereof
R²-[-A(O)OH]ₚ (V)
in which the index and the variables have the following meanings:
R² is an organic radical containing hydrophobic and/or hydrophilic substructures;
A is C, P(OH), O—P(OH), S(O) or O—S(O); and
p is from 1 to 10 000.

3. The curable composition as claimed in claim 2, wherein in the crystallization inhibitor (V), the organic radical R² is a low molecular mass, oligomeric or polymeric, carbon chain that is optionally branched and/or cyclic said carbon chain optionally containing heteroatoms selected from the group consisting of oxygen, phosphorus, nitrogen and sulfur heteroatoms, and/or substituted by radicals attached via oxygen, nitrogen, phosphorus or sulfur to the radical R².

4. The curable composition as claimed in claim 1, wherein the crystallization inhibitor is at least one of a carboxylic acid having at least two carboxylate groups and at least one hydroxyl group; an alkyl sulfate; an alkylbenzenesulfonate; a polyacrylic acid; or an optionally hydroxy-substituted diphosphonic acid.

5. The curable composition as claimed in claim 1, wherein the dispersant imparts to the barium sulfate particles a surface which inhibits agglomeration and/or prevents reagglomeration by at least one of electrostatically or osmotically.

6. The curable composition as claimed in claim 5, wherein the dispersant is a phosphoric diester including as substructures a polyether group and a C₆-C₁₀ alkenyl group.

7. The curable composition as claimed in claim 5, wherein the dispersant contains reactive groups for covalent attachment.

8. The curable composition as claimed in claim 7, wherein the reactive groups are at least one of hydroxyl groups or amino groups.

9. The curable composition as claimed in claim 5, wherein the dispersant is a polyetherpolycarboxylate substituted terminally on the polyether groups by hydroxyl groups.

10. The curable composition as claimed in claim 1, wherein the deagglomerated barium sulfate is used in the form of one of a suspension in water, an organic liquid, a mixture of water and organic liquid, or a suspension in a polymeric premix.

11. The curable composition as claimed in claim 1, wherein the deagglomerated barium sulfate is used as a dry, redispersible powder obtained by drying the deagglomerated barium sulfate.

12. A polymeric premix for curable compositions, comprising deagglomerated barium sulfate as claimed in claim 1.

13. The curable composition as claimed in claim 10, wherein the deagglomerated barium sulfate used in the preparation of the curable composition is in suspension in an aqueous phase.

14. The curable composition as claimed in claim 13, wherein the suspension of the deagglomerated barium sulfate has a solids content of from 0.1 to 30% by weight.

15. The curable composition as claimed in claim 13, wherein the suspension has a pH >7.

16. The curable composition as claimed in claim 1, wherein the deagglomerated barium sulfate is a catalyst for curing the curable composition.

17. The curable composition as claimed in claim 1, further comprising binders which contain at least one epoxide group (a1).

18. The curable composition as claimed in claim 17, wherein the binders are at least one of oligomers or polymers (A).

19. The curable composition as claimed in claim 17, wherein the oligomers or polymers (A) are at least one of hydrolysates prepared by hydrolyzing or condensates prepared by condensing, at least one oligomer or polymer (A) containing at least one epoxide group (a1) and at least one hydrolyzable silane group (a2).

20. The curable composition as claimed in claim 19, wherein the oligomers and polymers (A) containing at least one epoxide group (a1) and at least one hydrolyzable silane group (a2) are selected from the group of the addition copolymers of olefinically unsaturated monomers.

21. The curable composition as claimed in claim 20, wherein the oligomers and polymers (A) containing at least one epoxide group (a1) and at least one hydrolyzable silane group (a2) are addition (meth)acrylate copolymers.

22. The curable composition as claimed in claim 19, wherein the molar ratio of epoxide groups (a1) to hydrolyzable silane groups (a2) in an oligomer or polymer (A) is from 1.5:1 to 1:1.5.

23. The curable composition as claimed in claim 19, wherein the oligomer and the polymer (A) are prepared by copolymerizing at least one monomer (a1) containing at least one epoxide group (a1) with at least one monomer (a2) containing at least one hydrolyzable silane group (a2).

24. The curable composition as claimed in claim 23, wherein the monomers (a1) and (a2) are copolymerizable with at least one further monomer (a3) different from (a1) and (a2).

25. The curable composition as claimed in claim 23, wherein the monomers (a1), (a2) and (a3) contain at least one olefinically unsaturated group.

25. The curable composition as claimed in claim 25, wherein the olefinically unsaturated groups are methacrylate and/or acrylate groups.

27. The curable composition as claimed in claim 23, wherein the molar ratio of monomer (a1) to monomer (a2) is from 1.5:1 to 1:1.5.

28. The curable composition as claimed in claim 19, wherein the oligomers and polymers (A) containing at least one epoxide group (a1) and at least one hydrolyzable silane group (a2) are hydrolyzable and/or condensable at a pH <7.

29. The curable composition as claimed in claim 28, wherein the hydrolysis and/or condensation can be conducted in the presence of an organic acid.

30. The curable composition as claimed in claim 19, wherein the hydrolysis and/or condensation is conducted at from −10° C. to +80° C.

31. The curable composition as claimed in claim 1, wherein the deagglomerated barium sulfate is additionally modified with at least one modifier.

32. The curable composition as claimed in claim 31, wherein the modifier is at least one of acetic acid or propionic acid.

33-34. (canceled)

35. A material comprising the curable composition as claimed in claim 1, wherein said material is selected from the group consisting of a coating material, an adhesive, a sealant, a starting material for moldings and a starting material for self-supporting sheets.

36. A curable composition as claimed in claim 1 comprising a composition for shielding substrates from high-energy radiation.
